(19) United States
(12) Patent Application Publication
(10) Pub. No.: US 2025/0197248 A1
(43) Pub. Date: Jun. 19, 2025

(54) WATER TREATMENT SYSTEM

(71) Applicant: KEMIRA OYJ, HELSINKI (FI)

(72) Inventors: Marco STAMMEGNA, Atlanta, GA (US); Iris PORAT, Atlanta, GA (US)

(21) Appl. No.: 18/846,702

(22) PCT Filed: Mar. 15, 2023
(86) PCT No.: PCT/EP2023/056618

§ 371 Date: Sep. 13, 2024

Related U.S. Application Data
(60) Provisional application No. 63/320,340, filed on Mar. 16, 2022.

(30) Foreign Application Priority Data
Apr. 27, 2022 (FI) 20225357

(51) Int. Cl. C02F 1/00; C02F 1/66; C02F 1/72; C02F 3/12; C02F 3/30

(52) U.S. Cl. CPC C02F 1/008; C02F 1/66; C02F 1/722; C02F 3/12; C02F 3/308; C02F 2001/007; C02F 2209/003; C02F 2209/006; C02F 2209/008; C02F 2209/40; C02F 2303/04

(57) ABSTRACT

Provided herein is a water treatment system arranged to feed performic acid to water in need of disinfection, and control residual levels of performic acid. The system is responsive to changes in water quality and water quantity, and enables compliance with toxicity limits of disinfectant concentrations.

### FIELD OF THE INVENTION

The present disclosure generally relates to water treatment. The disclosure relates particularly, though not exclusively, to a water treatment system arranged to feed performic acid to water, and to control the amount of performic acid fed to water. The disclosure further relates to a method of treating water using controlled amounts of performic acid.

### BACKGROUND OF THE INVENTION

The need for purified water is increasing rapidly around the world. Efforts are being made to produce pure water from impure water using lower concentrations of chemical disinfectants, without, however, considerably raising the cost of the purification process. In addition, there is a need for the use of biodegradable or otherwise less harmful chemicals having fewer detrimental health effects.

Chlorine-based disinfectants (for example, hypochlorite, chlorine dioxide and chloramines) have traditionally been used to disinfect water, including wastewater. Chlorine-based disinfectants are quite effective against bacteria, but have lower efficiency against viruses, bacterial spores and protozoan cysts. In addition, chlorine-based disinfectants give rise to potentially toxic and mutagenic by-products, making them less desirable for use in disinfection processes.

Therefore, alternative disinfection methods have been considered. Among those, ultraviolet (UV) irradiation is currently the most widely used alternative disinfection method. It is typically efficient against enteric bacteria, viruses, parasite cysts and bacterial spores, and does not produce harmful by-products. However, if the UV dose is too low, photo-reactivation or dark repair of UV-damaged microorganisms can occur, leading to potential regrowth under favourable conditions Furthermore, UV-disinfection systems are highly dependent on upstream conventional treatment processes: UV is efficient only if the treated water quality is high (i.e. with low turbidity), as suspended solids can shield microorganisms from UV light. In addition, UV disinfection methods are relatively energy-intensive and expensive.

Other alternative disinfection methods such as ozonation, ultrasound and membrane filtration have been studied. However, these methods are generally more expensive and have their own drawbacks.

The organic peroxides peracetic acid (PAA or CH₃COOOH) and performic acid (PFA or HCOOOH) have more recently been considered as alternative disinfectants.

Peracetic acid (PAA or CH₃COOOH) is a broad-spectrum disinfectant with a high oxidation-reduction (redox) potential. PAA is commercially available as an acidic quaternary equilibrium mixture with acetic acid, hydrogen peroxide (H₂O₂), and water as illustrated in reaction (1) below:

CH₃COOH+H₂O₂ [symbol] CH₃CO—OOH+H₂O (1)

PAA is active against a wide spectrum of microorganisms. Disinfection mechanisms of PAA are based on the release of highly reactive oxygen species (ROS) such as hydroxyl (HO·), alkoxyl (RO·) and hydroperoxyl (HO₂·) radicals and superoxide (O₂·⁻). The ROS can alter the metabolism of microbes and damage the structure of microbial cells, which occurs due to chain reactions between the ROS and biomolecules such as enzymes, lipids, structural proteins and DNA. PAA produces little to no toxic/mutagenic by-products after reaction with organic material and degrades to acetic acid, hydrogen peroxide and water. However, the degradation of PAA to acetic acid in wastewater systems, and the presence of acetic acid in PAA formulations by virtue of equilibrium (1), raises the Biochemical Oxygen Demand (BOD). The BOD is a measure of the amount of oxygen needed or demanded by aerobic microorganisms to break down the organic matter present in a certain sample of water at a specific temperature and over a given time period. A high BOD signifies increased amounts of organic matter which in turn would encourage microbial growth.

Performic acid (PFA or HCOOOH) has been used to disinfect primary and secondary wastewater treatment plant effluents (see below for description of waste water treatment processes). The disinfection mechanisms of PFA are thought to be analogous to PAA via generation of ROS. PFA is considered to be more effective in disinfection than PAA (for example, requiring lower doses and/or shorter contact times) for inactivating at least some microorganisms including E. coli and Enterococcus. This may be attributable to the higher redox potential of PFA which provides a greater capacity to oxidise contaminants. The disinfectant properties of PFA are also effective at temperatures as low as 2.5° C. and therefore, PFA-based disinfection can also be applied in regions with cold climates and during the winter season. Analogously to PAA, PFA produces little to no toxic/mutagenic by-products after reaction with organic materials (Gehr et al., 2009, Water Sci. Technol. 59, 89-96). Additionally, PFA desirably causes a lower BOD than PAA, as formic acid, which is present in equilibrium with PFA in PFA preparations and is also a degradation product of PFA (see below), is not an effective substrate for bacterial consumption.

However, despite having a high disinfectant activity, PFA is very unstable and needs to be generated on-site, shortly prior to use, as a quaternary equilibrium mixture of PFA, formic acid, hydrogen peroxide and water, as shown below in reaction (2).

CHO—OH+H₂O₂ [symbol] CHO—OOH+H₂O (2)

PFA may spontaneously decompose in water to form formic acid and oxygen as illustrated by reaction (3) below. The formic acid may further degrade to water and carbon dioxide. PFA is also susceptible to hydrolysis, as illustrated by reaction (4) below.

2CHO—OOH [symbol] 2HCOOH+O₂ (3)

CHO—OOH+H₂O [symbol] CHO—OH+H₂O₂ (4)

When evaluating disinfectant systems, particularly in wastewater treatment systems, in addition to disinfection efficiency, consideration needs to be given to regulatory chemical discharge limits and effluent toxicity. The concentration of disinfectants in effluent must not exceed regulatory limits or be toxic. Accordingly, a simple over-dosing of chemical disinfectants such as PFA to compensate for diminished disinfection efficacy due to, for example, normal consumption, degradation or decomposition, could cause effluent toxicity and violation of regulatory discharge limits, as well as increasing operational costs.

It would be desirable to overcome the disadvantages associated with the disinfectant technologies described herein and provide an effective water treatment system and a method of treating water which enable effective disinfection and compliance with regulatory restrictions and requirements.

### SUMMARY OF THE INVENTION

Accordingly, in a first aspect, the present invention provides a water treatment system. The water system comprises:
at least one chamber comprising an inlet for receiving water and an outlet for discharging water therefrom,
a dosing device configured to feed performic acid to the water in the at least one chamber to produce treated water,
a measuring device configured to measure the level of performic acid in the treated water and generate output data relating to the measured level of performic acid,
and a control apparatus operatively connected to the dosing device and measuring device,
wherein the control apparatus is constructed and arranged to receive the output data relating to the measured level of performic acid from the measuring device, to monitor the measured level of performic acid present in treated water, and to regulate the amount of performic acid that is fed to the water by the dosing device based on the monitored level of performic acid.

In a second aspect, the present invention provides a method for treating water using the system above. The method comprises:
receiving water;
feeding performic acid to the water to form treated water;
measuring the level of performic acid in the treated water,
monitoring the level of performic acid in the treated water and regulating the amount of performic acid that is fed to the water based on the monitored level of performic acid.

Preferred features of all aspects of the present invention are defined in the dependent claims.

The system and method defined herein are particularly useful in wastewater treatment. The present inventors have found that the system and method may advantageously minimise or even eliminate fluctuations in a target concentration of residual PFA, thus achieving optimal disinfection performance and meeting microbial limits whilst remaining below toxic levels, and achieving compliance with regulatory limits for PFA and regulatory microbiological limits.

### BRIEF DESCRIPTION OF FIGURES

To assist understanding of the present disclosure and to show how embodiments may be put into effect, reference is made, by way of example only, to the accompanying drawings in which:

FIG. 1 is a schematic diagram illustrating a dosing device comprising a reaction vessel for producing PFA according to an example of the invention.

FIG. 2 is a schematic block diagram illustrating a control apparatus according to an example of the invention.

FIG. 3 is a schematic diagram illustrating a wastewater treatment system according to an example of the invention under normal conditions (bottom) and under conditions of a combined sewer overflow (CSO) (top).

FIG. 4A is a line graph comparing the disinfection efficacy of PFA against fecal coliform in a sample of wastewater that has undergone secondary treatment and a sample containing 50% wastewater that has undergone secondary treatment and 50% waste water that has undergone only primary treatment without secondary treatment.

FIG. 4B is a line graph comparing the disinfection efficacy of PFA against E. coli in a sample of wastewater that has undergone secondary treatment and a sample containing 50% wastewater that has undergone secondary treatment and 50% wastewater that has undergone only primary treatment without secondary treatment.

FIG. 5 is a line graph illustrating residual levels of PFA in wastewater samples that have been treated with varying doses of PFA.

FIG. 6A is a line graph illustrating monitored levels of residual PFA and PFA dosing in a system according to an example of the invention.

FIG. 6B is a line graph illustrating monitored levels of residual PFA when a constant dose of PFA is applied.

FIG. 6C is a box chart illustrating minimum, maximum and mean levels of residual PFA when PFA dosing is controlled according to an example of the invention and when a constant dose of PFA is applied.

FIG. 7 is a line graph comparing PFA measurements using two online devices (Hach® Cl-17 and Xylem®-3017M) and a manual method (CHEMetrics K-7913 kit).

### DETAILED DESCRIPTION OF THE INVENTION

Regardless of the disinfection technology, disinfection performance is primarily governed by the target concentration of residual disinfectant. The term “concentration of residual PFA” means the concentration of PFA after a period of contact with (or exposure to) water to be treated. Thus, if a constant concentration of residual disinfectant is dynamically maintained during the disinfection process, then consistent disinfection performance will be met. However, with specific regard to the use of PFA as a disinfectant in wastewater treatment systems, it is difficult to maintain a constant concentration of residual PFA due to uncontrolled, large variations in water quality and quantity, as well as numerous side reactions between the disinfectant and water contaminants. For example, when added to wastewater, PFA undergoes an initial rapid consumption (i.e. instantaneous disinfectant demand) followed by a more gradual decay. As a result, dosing strategies which do not take into account demand and/or decay may result in insufficient PFA performance and possible violations of regulatory microbial limits. Similarly, over-dosing with higher levels of PFA than actually required for optimal disinfection may result in increased operational and environmental costs (through increased consumption of disinfectant and higher potential formation of undesirable disinfection by-products), in addition to the potential violation of regulatory residual chemical limits.

The present invention provides a water treatment system which may serve to maintain residual levels of PFA, and which may be responsive to any variations in water quality and quantity, and to microbial counts. The system may accordingly enable compliance with microbial reduction targets and other regulatory discharge restrictions and limits.

The water system comprises:
at least one chamber comprising an inlet for receiving water and an outlet for discharging water therefrom,
a dosing device configured to feed performic acid to the water in the at least one chamber to produce treated water,
a measuring device configured to measure the level of performic acid in the treated water and generate output data relating to the measured level of performic acid, and a control apparatus operatively connected to the dosing device and measuring device,
wherein the control apparatus is constructed and arranged to receive the output data relating to the measured level of performic acid from the measuring device, to monitor the measured level of performic acid present in treated water, and to regulate the amount of performic acid that is fed to the water by the dosing device based on the monitored level of performic acid.

Further provided is a method for treating water. The method comprises:
receiving water;
feeding performic acid to the water to form treated water;
measuring the level of PFA in the treated water, and
monitoring the level of PFA in the treated water and regulating the amount of PFA that is fed to the water based on the monitored level of PFA.

Preferably, the method is carried out using the system as defined herein.

The water to be treated is not particularly limited, and is any water or aqueous solution in need of disinfection treatment. The water to be treated may include raw water, drain water, water used in agriculture, or wastewater. The water to be treated typically includes one or more contaminants such as bacteria, viruses, and other non-living organic matter. In preferred embodiments, the water treatment system comprises a wastewater system. The wastewater to be treated may include municipal wastewater, sewage and/or industrial wastewater.

The chamber for receiving water to be treated is not particularly limited and can be any container capable of holding the received water and discharging the treated water. The chamber may be of any form or shape. For example, the chamber may be in the form of a tube, channel, pipe or section thereof, cylinder, barrel, container, vat, reservoir or the like.

### Production and Feeding of PFA

Due to the instability and fast decomposition times of PFA, PFA may need to be generated immediately before use. Preferably, PFA may be generated by the dosing device in situ (i.e. within the water treatment system itself). As such, the dosing device of the water treatment system may comprise a reaction vessel in which PFA is produced. In other embodiments, PFA is produced outside the water treatment system and transferred directly and rapidly to the dosing device for feeding to water. A preferred preparation method of PFA comprises mixing formic acid with hydrogen peroxide according to reaction (2) below optionally, in the presence of an acid catalyst such as sulphuric acid, ascorbic acid, or boric acid. The equilibrium of reaction (2) may be shifted in favour of PFA formation if the molar ratio of formic acid to hydrogen peroxide is increased, or by removing water from the reaction.

CHO—OH+H₂O₂ [symbol] CHO—OOH+H₂O (2)

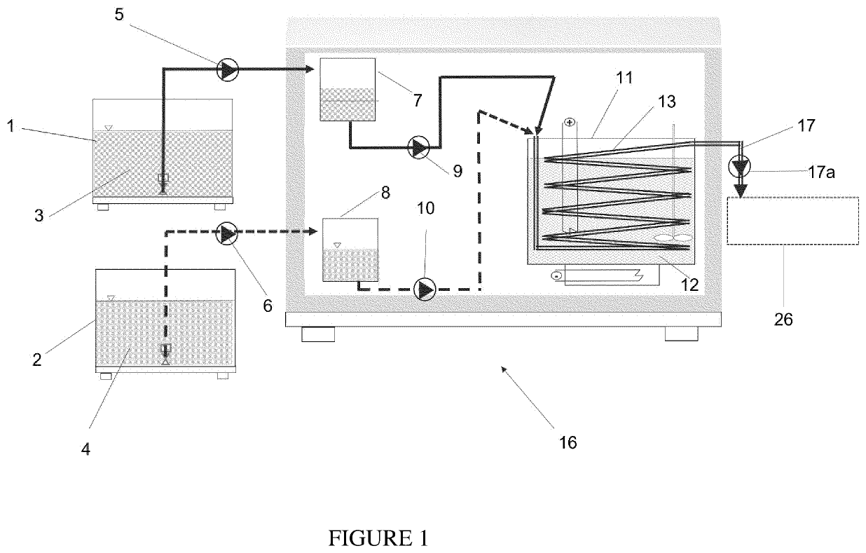

With reference to the schematic illustration of FIG. 1, in an example of the invention, the dosing device (16) comprises two external storage tanks (1, 2) for the reagents (35-50% hydrogen peroxide (3) and 70-90% formic acid (4), respectively). Solutions of reagents (3,4) are transferred from the external storage tanks (1,2) via transfer pumps (5,6) to two respective internal buffer tanks (7,8). A second set of transfer pumps (9,10) transfer solutions of reagents (3,4) to a reactor (11). The reactor (11) is submerged in a thermostatic bath (12) and comprises a coil (13) in which the reagents combine and are allowed to react for a required amount of time (contact time) to produce PFA. PFA is then transferred out of the reactor for subsequent feeding to water in a chamber (26) via PFA line (17). Automatic control of key variables such as temperature, pressure, liquid levels, and flow rates may ensure optimal and stabilised process conditions. In some examples, the temperature of dosing device (16) is maintained at 20° C. In response to increased or decreased demands for disinfection, a control apparatus which is operatively connected to the dosing device (16), may adjust the rate of production of PFA. In some embodiments, the rate of production of PFA may be regulated by modifying the velocity of one or both transfer pumps (9,10). In a basal state, the rate of flow of reagents (3,4) through each of the transfer pumps (9, 10) may be from about 2.5 ml/hour to about 60 litres/hour, or from about 2.5 ml/hour to about 7.5 litres/hour, or from about 75 ml/hour to about 60 litres/hour, or from about 100 ml/hour to about 40 litres/hour. In these embodiments, the rate of flow of PFA solution out of reactor (11) may be twice the rate of flow of reagents (3,4) through each of the transfer pumps (9, 10). An increase in velocity of the pumps (9, 10) has the effect of increasing the rate of flow of reagents and accordingly, increasing the volume of reagent solutions (3,4) entering the reactor (11) within a given period of time. A higher volume of reagent solution (3, 4) will increase the amount of PFA (i.e. volume of PFA solution) that is produced within a given period of time, and accordingly, increase the amount of PFA solution that enters PFA line (17) and into the chamber (26) within a given period of time. Thus, in this example, the dosing concentration of PFA will be consequentially increased. Conversely, a decrease in velocity of the pumps (9, 10) will have the effect of decreasing the volume of reagent solutions (3,4) entering the reactor (11) within a given period of time. A lower volume of reagent solutions (3, 4) will decrease the amount of PFA (i.e. volume of PFA solution) that is produced within a given period of time, and accordingly, decrease the amount of PFA solution that enters PFA line (17) and into the chamber (26) within a given period of time. Thus, in this example, the dosing concentration of PFA will be consequentially decreased. PFA may be present in the solution that is formed in the reactor in an amount of from about 8% to about 15%, on a weight to volume basis.

In some embodiments, the water treatment system is a continuous system. In an example of the invention, a PFA solution comprising from about 8% to about 15% PFA, on a weight to volume basis, is continually fed from the dosing device (16), in which it may be produced, into the chamber (26) containing water to be treated via a PFA line (17). The PFA line (17) may comprise at least one exit pump (17a). The PFA solution may be fed into the water to be treated at a basal flow rate to achieve a basal PFA dosing concentration (i.e. concentration of PFA in the water to be treated at the point of feeding). The flow rate of PFA solution into the chamber (26) and accordingly, the dosing concentration of PFA, may be continually adjusted from the basal level based on changes in demands for disinfection as described above.

The flow rate of the PFA solution may be from about 5 ml/hour to about 120 litres/hour, or from about 5 ml to about 15 litres/hour, or from about 150 ml/hour to about 120 litres/hour, or from about 200 ml/hour to about 40 litres/hour. The flow rate may vary depending on the size of the water treatment system and accordingly, on the amount of water to be treated. The rate of flow of water in a wastewater treatment system may vary from about 500 m³/day to about 600,000 m³/day. In some wastewater treatment systems, the rate of flow of water may be from about 1000 m³/day to about 300,000 m³/day or from about 10,000 m³/day to about 50,000 m³/day. For an exemplary PFA solution produced in the dosing device at a concentration of from about 9 to 10 wt. % PFA, the volume of PFA solution fed to the water to be treated may range from about 4 ml/m³ to about 45 ml/m³ of water to be treated. In alternative terms, the dosing concentration of PFA may be from about 0.2 ppm to about 10 ppm, or from about 0.5 ppm to about 5 ppm, or from about 0.5 to about 2 ppm.

In response to increased or decreased demands for disinfection, in an example of the invention, the control apparatus may further adjust the rate of flow of PFA solution from the dosing device (16) into the chamber (26) through PFA line (17) by adjusting the operational velocity of the at least one exit pump (17a). An increase in velocity of the at least one exit pump (17a) will increase the flow rate of the PFA solution and consequently increase the dosing concentration of PFA. Conversely, a decrease in velocity of the at least one exit pump (17a) will decrease the flow rate of the PFA solution and consequently decrease the dosing concentration of PFA. Any change in rate of flow of PFA solution from the dosing device would preferably be supported by a corresponding change in the rate of flow of reagents (3,4) into the reactor (11) to ensure sufficient amounts of PFA are produced.

Other arrangements for controlling the rate of flow of PFA solution from the dosing unit into to the chamber are also envisaged. For example, a PFA line (17) may transfer PFA solution from the dosing device (16) to the water to be treated, and transfer of PFA may be controlled by the operation of one or more valves within the line (not shown).

In some embodiments, the control apparatus may control the dose of PFA by regulating both the rate of production of PFA within the dosing device (16) and by regulating the rate of flow of PFA solution from the PFA line (17) into the chamber (26), as described above.

Accordingly, the control apparatus may comprise a computing apparatus. In one example, the invention provides a control apparatus comprising at least one processor, and at least one memory including a computer program code, the at least one memory and the computer code being configured, with the at least one processor, to cause the apparatus to perform any of the methods described herein.

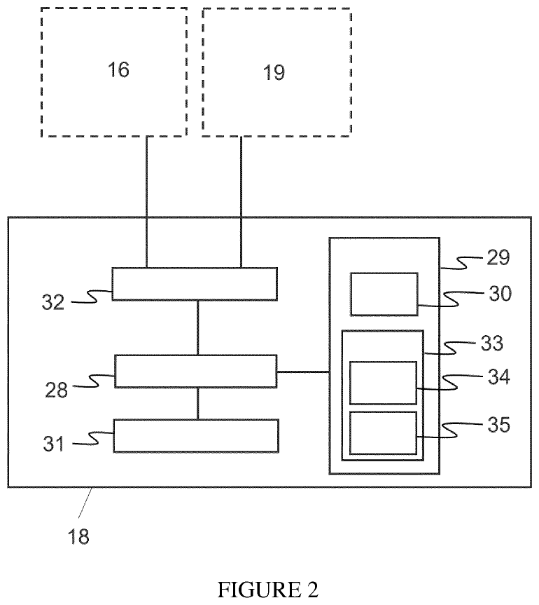

FIG. 2 is a block diagram of control apparatus (18) according to an example of the invention. The control apparatus (18) is suitable for implementing at least some of the operations described herein. With specific reference to FIG. 2, the control apparatus (18) may comprise at least one processor (28), at least one memory (29), a communication interface (32) and a user interface (31). The control apparatus may further comprise other internal circuitry and components necessary to perform the tasks described herein. The control apparatus (18) may be constructed and arranged to receive output data from the measuring device (19) to monitor the level of PFA present in treated water as measured by measuring device (19), and to regulate the feeding of PFA from the dosing device (16).

The control apparatus (18) may comprise a communication interface (32) for connecting the control apparatus to a data communications system and enabling data communications with the apparatus. The communication interface (32) may comprise a wired and/or wireless communication circuitry, such as Ethernet, Wireless LAN, Bluetooth, GSM, CDMA, WCDMA, LTE, 5G circuitry, and/or analog. The communication interface can be integrated in the control apparatus (18) or provided as a part of an adapter, card or the like, that is attachable to the control apparatus (20). The communication interface (32) may support one or more different communication technologies. The control apparatus (18) may also or alternatively comprise more than one communication interface (32).

The user interface (31) may comprise a circuitry for receiving input from a user of the control apparatus (18), for example, via a keyboard, graphical user interface shown on the display of the apparatus, speech recognition circuitry, or an accessory device, such as a headset, and for providing output to the user via, for example, a graphical user interface or a loudspeaker. The control apparatus may be operated remotely.

The at least one processor (28) may be coupled to the at least one memory (29). The at least one processor (28) may be configured to execute an appropriate computer program code to implement one or more of the aspects described herein. The at least one processor (28) may be a central processing unit (CPU), a microprocessor, a digital signal processor (DSP), a graphics processing unit, an application specific integrated circuit (ASIC), a field programmable gate array, a microcontroller or a combination of such elements.

The at least one memory (29) may comprise a work memory (30) and a persistent (non-volatile, N/V) memory (33) configured to store computer program code (34) and data (35). The memory (33) may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like. The control apparatus (18) may comprise other possible components for use in software- and hardware-aided execution of tasks it is designed to perform.

The control apparatus (18) may comprise a plurality of memories (33). The memory (33) may be constructed as a part of the control apparatus (18) or as an attachment to be inserted into a slot, port, or the like of the apparatus (18) by a user or by another person or by a robot. The memory (33) may serve the sole purpose of storing data, or be constructed as a part of an apparatus (18) serving other purposes, such as processing data.

The skilled person would understand that in addition to the elements shown in FIG. 2, the control apparatus (18) may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the control apparatus (18) may comprise a disposable or rechargeable battery (not shown) for powering the apparatus (18) if an external power supply is not available. Further, it is noted that only one apparatus (18) is shown in FIG. 2, but certain embodiments may equally be implemented in a cluster of shown apparatuses.

In some embodiments, the control apparatus (18) may be configured to receive input of specific parameters, for example, a pre-defined target concentration of residual PFA. The specific parameters may be input through the user interface (31). In these embodiments, based on output data received from the measuring device (17), the control apparatus (18) may detect an increase in concentration of residual PFA above the pre-defined concentration (for example, when there is a decreased demand for disinfection), and cause the dosing device (16) to decrease the amount of PFA that is fed to the water to be treated over a given period of time to restore the concentration of residual PFA to the pre-defined target value. This may be effected, as described above, by decreasing the velocity of pumps (9, 10) which deliver reagents (3, 4) to reactor (11) for PFA formation and/or by decreasing the rate of flow of PFA solution from the dosing apparatus (16) to chamber (26) through an exit pump (17a) in the PFA line (17). Conversely, based on output data received from the measuring device (17), the control apparatus (18) may detect a decrease in concentration of residual PFA below the pre-defined value (for example, when there is an increased demand for disinfection) and cause the dosing device (16) to increase the amount of PFA that is fed to the water to be treated over a given period of time to restore the residual PFA concentration to the pre-defined target value. This may be effected, as described above, by increasing the velocity of pumps (9, 10) which deliver reagents (3, 4) to reactor (11) for increased PFA formation and/or by increasing the rate of flow of PFA solution from the dosing apparatus (16) to chamber (26) through an exit pump (17a) in the PFA line (17). An appropriate computer program code (34), as executed by the processor (28) and stored in memory (29), may determine, based on output measurement data received from measuring device (17), whether the measured level of residual PFA is above or below the pre-defined value, and the adjustment required in the amount of PFA that is fed to the water in order to restore the level of residual PFA to the pre-defined value, as described herein. Accordingly, the control apparatus (18) may be constructed and arranged to compare the measured residual PFA concentration with the pre-defined concentration of residual PFA, and may be constructed and arranged to adjust the performance of the dosing device (16).

In an example of the invention, the at least one processor (28) may comprise a proportional-integral-derivative (PID) controller. A PID controller is a control loop mechanism employing feedback that is widely used in industrial control systems and in a variety of other applications requiring continuously modulated control. The PID controller may continuously calculate an error value as the difference between the pre-defined set concentration of residual PFA and the measured concentration of residual PFA, and may subsequently apply a correction based on proportional, integral, and derivative terms. The controller may attempt to minimize the error over time by adjustment of its output (for example, by adjustment of the velocity of the reagent pumps (9, 10) and/or velocity of the exit pump (17a)) such that the pre-defined set concentration of residual PFA can be maintained. In another example, a PI (proportional, integral)-based controller is used.

The pre-defined target value of PFA may be determined on the basis of relevant regulatory limits governing the area in which the water treatment system is located. In some embodiments, the pre-defined target value of PFA may be from 0.3 mg/l to 1 mg/l, or from 0.4 mg/L to 0.6 mg/L.

### Measuring Level of PFA in Water

In the system and method for treating water according to the present invention, the level of residual PFA may preferably be measured and monitored continuously and in real-time in order to detect any fluctuations from a target level of residual PFA. By “continuous” it is meant that the level of PFA is measured and recorded at regular, repeating intervals without interruption. For example, the level of PFA in water may be measured and recorded at regular intervals from 1 minute to 5 minutes. Preferably, the level of PFA in water is measured and recorded every 2 minutes, every 2.5 minutes, every 3 minutes, every 3.5 minutes, or every 4 minutes. Most preferably, the level of PFA in water is measured every 2.5 minutes.

Preferably, the measurement of PFA is performed online. In other embodiments, the measurement of PFA is performed inline. Inline and online measurements are both forms of continuous, in situ measurement. Online measurements are not made directly in the main process line, but rather in a built-in branch or by-pass (for example, a sampling loop) into which samples of water containing PFA are automatically fed. Inline measurements are made directly in the main process line which requires placing a probe or sampling interface directly into or in line with the process flow. For PFA measurement methods requiring additional reagents to measure PFA (for example, colorimetric methods as described below), online measurement configurations are preferred.

Due to the requirement of continuous monitoring of the levels of PFA, and the exceptionally fast decomposition times of PFA, a rapid method of measuring PFA is required.

In some embodiments, levels of PFA in the water may be measured by amperometric techniques. Amperometry is based on the measurement of the current resulting from the electrochemical oxidation or reduction of an electroactive species. A typical amperometric sensor consists of two dissimilar electrodes—a working electrode and a reference electrode. One example of an amperometry sensor for use in the system and method of the present invention is a Hach® Cl-10 analyser. A constant polarization voltage is applied between the two electrodes and this causes an electrochemical reaction of PFA at the working electrode. The measured current is used as the main signal for detection and is proportional to the PFA concentration near the electrode. In accordance with standard methods, the probe requires calibration to provide a reference PFA concentration.

In preferred embodiments, levels of PFA in the water are measured by a colorimetric method. Preferably, the colorimetric method uses a DPD (N,N-diethyl-p-phenylelnediamine) analyser. For many years, the DPD method has been the most commonly used method for determining free chlorine and total chlorine in water. In the DPD method, the sample containing PFA is treated with an excess of potassium iodide (KI). The PFA oxidizes the iodide to iodine. The iodine subsequently oxidizes the DPD to a pink coloured species. The pink colour will be in direct proportion to the amount of PFA in the sample and can be quantified via comparison to a standard colour chart or measured via photometer. Appropriate correction factors are applied to account for the difference in molecular weight between PFA and Chlorine.

DPD kits and photometers are commercially available. Examples of DPD analysers which may be used for online measurements include Hach® CL-17 analyser, Hach® CL-17sc analyser, or a Xylem® 3017M analyser.

As mentioned above, PFA typically exists in equilibrium with formic acid and hydrogen peroxide when in an aqueous solution. Hydrogen peroxide will not interfere with the DPD test method if the peroxide is in the same general concentration range as the peracetic acid. Hydrogen peroxide interference may further be avoided by adjusting the concentrations of the reagents used in the DPD method (i.e. KI and DPD) and the time of reaction with the reagents. Lower concentrations of the reagents and shorter reaction times enable hydrogen peroxide interference to be eliminated. The precise conditions for measuring PFA would readily be determined by the skilled person. Appropriate calibration in accordance with standard methods is preferably conducted for achieving accurate measurements.

Additionally, various oxidants present in wastewater, such as halogens, ferric ions and cupric ions can induce interference with the method, producing high test results. Incorporation of a “blank” measurement helps to eliminate the impact of interference from wastewater constituents. The blank measurement consists of running a DPD test on a sample of the wastewater without added PFA. Any subsequent absorbance measurement from the blank sample can then be subtracted from the absorbance measurement of the PFA test sample, proving a more accurate quantification of PFA.

Other colorimetric methods of measuring PFA are known in the art. Wagner et al., 2002 (Water Environ. Res. 41 (1), 33-50) have developed a method for measuring PAA using an ABTS-HRP (2,2″-azino-bis[3-ethylbenzothiazoline-6-sulfonic acid] diammonium salt—horseradish peroxidase) colorimetric assay which can be adapted to measure PFA. ABTS is oxidized to its radical cation (ABTS⁺) by PFA and H₂O₂ in aqueous solution, due to the catalytic function of HRP. The amount of oxidised ABTS⁺ in the solution is determined by measuring absorbance at 405 nm. As both PFA and H₂O₂ oxidise ABTS to ABTS⁺, a calibration curve must be appropriately constructed. Alternatively, a sample may be treated with catalase to eliminate H₂O₂ interference.

### Wastewater Treatment

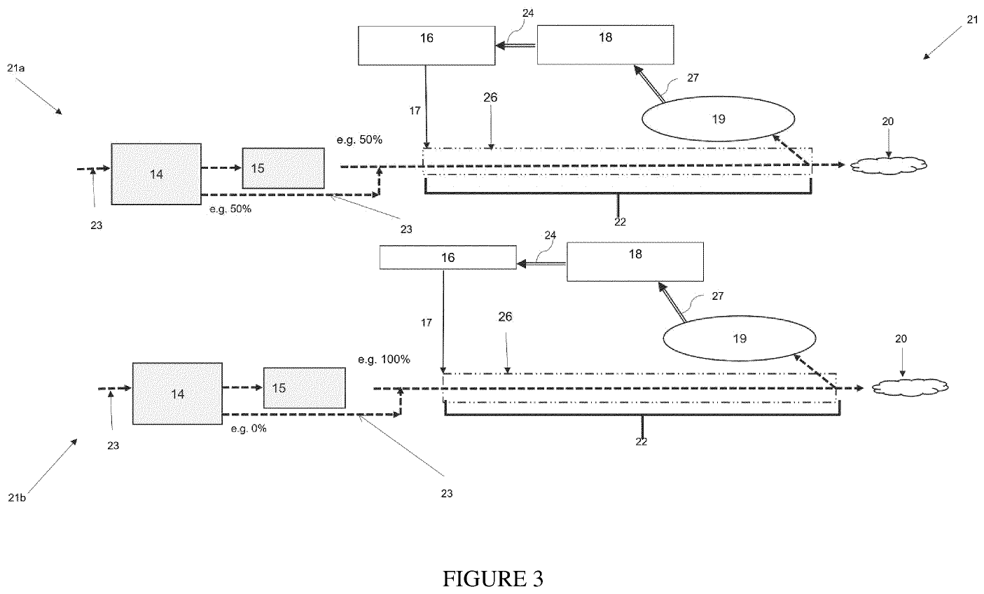

In preferred examples, the water to be treated comprises wastewater, and the water treatment system comprises or is provided within a wastewater treatment system or plant. An exemplary wastewater treatment system is illustrated in FIG. 3.

Municipal wastewater or sewage treatment generally involves three sequential processes: primary, secondary and tertiary treatments. These are well-known to a person skilled in the art of wastewater treatment and water purification, and further discussed below.

With specific reference to the wastewater system depicted in FIG. 3, prior to primary treatment (14), a preliminary treatment may remove all materials and large debris that can be easily collected from the raw sewage or wastewater (23) before they damage or obstruct any pumps and sewage lines of primary treatment apparatuses.

The primary treatment (14) is designed to remove gross, suspended and floating solids from raw sewage or wastewater (23). Primary treatment (14) may include screening to trap solid objects and sedimentation by gravity to remove suspended solids (removed and collected as sludge). The sedimentation process may be accelerated by the use of chemicals. The total suspended solids concentration (TSS) is an effective indicator of primary treatment (14). The TSS represents the weight proportion of fine particulate matter that remains in suspension per unit volume of water. Primary treatment (14) may reduce the TSS concentration to 40 to 50%.

After the primary treatment (14), the wastewater (23) may be directed to a secondary treatment (15) which typically includes biological treatment steps and sedimentation. Specifically, primary effluent may be subjected to an activated sludge technique in which the effluent is aerated, and aerobic microorganisms metabolise organic matter to carbon dioxide and water, and reproduce to form a microbial community. Organic nitrogen compounds may be converted to ammonia and subsequently nitrate. A secondary sedimentation tank may allow the microorganisms and solid wastes to agglomerate and settle as sludge. At least some of the collected sludge (activated sludge) may then be recycled for use as an inoculum for biological treatment of further incoming wastewater.

The secondary treatment (15) may reduce the TSS content to 10 to 15%. The Biochemical Oxygen Demand (BOD) is a further indicator of secondary treatment. As mentioned above, the BOD is a measure of the amount of oxygen needed or demanded by aerobic microorganisms to break down the organic matter present in a certain sample of water at a specific temperature and over a given time period. Secondary treatment (15) typically reduces the BOD to 10 to 15%.

Alternative or additional processes carried out during secondary treatment (15) may include biofiltration and oxidation ponds. Biofiltration requires the use of microorganisms immobilised on filters (e.g. sand filters, contact filters or trickling filters) to decompose organic matter and remove additional sediment. Oxidation ponds involve passing wastewater through large bodies of water (e.g. lagoons) in sunlight for extended periods of time to enable microorganisms to decompose organic matter.

Primary and secondary treatments (14, 15) are often sufficient for many purposes and not all wastewater treatment plants use tertiary treatment. Those that do use tertiary treatment achieve more stringent levels of cleanliness to meet the exacting standards that govern water reuse, especially in public water supplies. Tertiary treatment is also beneficial when facilities must discharge water into sensitive or fragile ecosystems (for example, estuaries, low-flow rivers, coral reefs, etc). Tertiary treatment may include filtration, disinfection and removal of nitrogen and phosphorus (not shown in FIG. 2).

In some embodiments, the water treatment system of the invention may be configured to perform one or more of primary, secondary and tertiary treatments, or the method of the invention may comprise performing one or more of primary, secondary and tertiary treatments. Water received by the system, and more specifically the chamber, may have undergone primary, secondary and tertiary treatment carried out by the system. In other embodiments, the water may have undergone primary treatment carried out by the system without secondary and tertiary treatments. In further embodiments, the water may have undergone primary and secondary treatments carried out by the system, without tertiary treatment. (See discussion of combined sewer overflow (CSO) below.)

However, it is to be noted that in alternative embodiments, primary, secondary and/or tertiary treatments may be performed elsewhere (for example, at another treatment plant), and therefore, not by the system of the present invention. In these embodiments, the water that is received may have undergone primary treatment, secondary treatment and tertiary treatment by another system that is not the system of the invention. In other embodiments, the water that is received may have undergone primary treatment by another system that is not the system of the invention without secondary and tertiary treatments. In further embodiments, the water that is received may have undergone primary and secondary treatments by another system that is not the system of the invention without tertiary treatment.

With further reference to FIG. 3, the level of residual PFA may be measured by the measuring device (19) at any point in the water treatment system (21) after PFA is fed into the water. Preferably, the measurement is commenced after a sufficient contact time (22) (i.e. time between addition of PFA to water and measurement) has elapsed. A contact time of at least 5 minutes, 10 minutes, 20 minutes or 30 minutes is desirable. In some examples, a contact time of at least one hour or two hours is provided. In a continuously flowing system, this means that measurement is performed at a flowing distance of at least 5 minutes, 10 minutes, 20 minutes, 30 minutes, one hour or two hours downstream of the point at which PFA is fed into the water. For example, the level of PFA may be measured prior to discharge from the at least one chamber (26) or after discharge from the at least one chamber (26). In a wastewater treatment system as described above, the level of PFA is preferably measured after the last treatment step, for example, after secondary treatment, or after tertiary treatment, if present, and prior to discharge of water into the environment (20).

### Combined Sewer Overflow (CSO) and Effects on PFA

In some embodiments the water treatment system comprises or is provided within a combined sewer system where wastewater and rain water are transported in the same sewers. Combined sewer overflow (CSO) is a well-known phenomenon which occurs when the rainfall exceeds the design capacity of sewer systems and wastewater needs to be discharged to surface water, for instance at a pumping station, where the pump does not have enough capacity to forward all the water. A CSO event means that some of the water is released without sufficient treatment or even with no treatment at all. This can have a harmful impact on the recipient water but also on the wastewater treatment plant (WWTP) itself since effluent demands are not met. Since WWTPs normally remove greater than 90 to 95% of the impurities in the water, a minor release of untreated wastewater can have a significant impact on the fulfilment of requirements.

Normally the secondary (biological) treatment step is the most sensitive unit during high water levels. The secondary sedimentation capacity may not be sufficient, and more suspended solids are released, causing values to be too high in treated water. A high level of total suspended solids (TSS) will also negatively impact the disinfection efficiency of PFA as PFA will oxidise organic matter contained in the TSS. One way to address this problem is to dose a small amount of polymer in the influent to the secondary settling tanks. Both anionic and cationic polyacrylamides are used for this purpose. The charge of the polymer depends on the sludge characteristics. With the addition of a polymer, the surface load on the secondary sedimentation can be increased. However, if the volume and/or flow rate of the water is too high, some of the wastewater may by-pass the secondary (biological) treatment step to minimise activated sludge being flushed away and a consequential disruption of the normal functioning of the WWTP which may require a long recovery time. This is illustrated in embodiment 21a of FIG. 2. If the water bypasses secondary (biological) treatment (15), it is normally subject to at least primary treatment (14). In extreme cases, even the primary treatment (14) may be bypassed (not shown).

Consequently, in some embodiments, the water treatment system (21) comprises a sensor or detector for measuring the volume and/or flow rate of water flowing therethrough. In a default state or first configuration (21b), the volume and/or flow rate of water detected by the system may be below a threshold or pre-set level. In these embodiments, the system may be configured to perform primary (14), secondary (15), and optionally, tertiary (not shown) treatments. The water received for PFA treatment in chamber (26) would thus have a high level of purity.

With further reference to FIG. 3, when a CSO event occurs, an exemplary system of the invention, if configured to perform the primary (14), secondary (15) and optionally, tertiary treatments, may detect an increased volume and/or flow rate of water relative to a threshold or pre-set level. In these circumstances, to avoid over-capacity issues, water may be diverted to bypass specific stages of treatment as described above. In one embodiment, the system switches to a second configuration (21a) in which water undergoes primary treatment (14), bypasses secondary treatment (15) (and consequently, tertiary treatment if the system is configured to provide such treatment), and is subsequently received in chamber (26) for treatment with PFA. In this embodiment, in the absence of secondary treatment (15), the quality of water is poor with high microbial counts, high levels of TSS, and high levels of organic matter. Additionally, the contact time with PFA may be reduced as the volume and/or flow-rate of water increases. Under some circumstances when the CSO event is severe (for example, with very high levels of rainwater), and the volume and/or flow-rate of water increases significantly relative to a threshold or pre-set level, the primary treatment itself may be bypassed.

In another embodiment, in the first configuration, the system is configured to perform primary, secondary and tertiary treatments as described above. When a CSO event occurs, the system may detect an increased volume and/or flow-rate of water relative to a threshold or pre-set level. This may cause the system to switch to a second configuration in which water undergoes primary and secondary treatment, but bypasses tertiary treatment.

PFA is a non-specific oxidant that will oxidize any organic material including bacteria, viruses, and non-living organic matter. The disinfection efficiency of PFA is thus dependent upon the quality of water to be treated. Poor quality water with high microbial counts, high TSS and high levels of other organic matter will consume increased amounts of PFA, and may further increase the rate of decomposition or degradation of PFA. Thus, when a CSO event has occurred as in embodiment 21a of FIG. 3, and the quality of water to be treated diminishes due to the bypassing of specific treatments (i.e. secondary and/or tertiary treatments), the level of residual PFA may also fall. During the CSO event, as discussed above, there may also be a reduced contact time between the wastewater and PFA due to an increased volume and/or flow-rate of water, further reducing the disinfection efficacy of PFA, increasing microbial counts and causing increased PFA consumption. In these circumstances, the control apparatus (18) of the system of the present invention is able to detect the fall in levels of residual PFA by the real-time and continuous monitoring of the PFA levels, based on output data from the measuring device (19) received by electronic signalling (27). Consequently, the control apparatus (18), which is operatively connected to the dosing device (16) through electronic signalling (24), may cause an increase in the amount of PFA that is fed to the water to be treated in chamber (26) through a PFA line (17). The increased amount of PFA that is fed to the water may be achieved by increasing the rate of production of PFA in the dosing apparatus (16) (for example, by increasing the velocity of one or more pumps delivering reagents for PFA synthesis to the reaction vessel or reactor where PFA synthesis takes place), and/or by increasing the rate of flow of PFA solution from the dosing apparatus (16) to the treatment chamber through the PFA line (17) (for example, by increasing the velocity of an exit pump (17a) positioned the line or by opening a valve positioned in the line) as described above.

Once the CSO event has terminated, and the volume and/or flow-rate of water flowing through the system (22) has returned to a normal/basal levels that is below the threshold or pre-set level, the normal first configuration (21b) is resumed, and the wastewater (23) undergoes primary (14) and secondary (15) treatments. Consequently, the quality of the water improves, and residual PFA levels may increase towards basal levels. The control apparatus (18), which is operatively connected to the measurement device (19) by electronic signalling (27) may detect the increase in levels of residual PFA. Subsequently, the control apparatus (18) which is also operatively connected to the dosing apparatus (16) via electronic signalling (24), may cause a reduction in the amount of PFA that is added to the water to be treated in chamber (26) through the PFA line (17). The decreased amount of PFA that is fed to the water may be achieved by decreasing the rate of production of PFA in the dosing apparatus (16) (for example, by decreasing the velocity of one or more pumps delivering reagents for PFA synthesis to the reaction vessel or reactor where PFA synthesis takes place), and/or by decreasing the rate of flow of PFA from the dosing device (16) to the treatment chamber (26) through the PFA line (17) (for example, by decreasing the velocity of a pump (17a) positioned in the line or by closing a valve positioned in the line).

It will be understood that the processor or processing system or circuitry referred to herein, with particular reference to the control apparatus, may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The present invention as described herein provides an automated disinfection system and method for disinfection using PFA. The higher redox potential and higher disinfection efficiency of PFA, combined with the increased susceptibility of PFA to degradation as compared to other disinfectants such as PAA, renders PFA a useful target for regulation in the treatment system described herein. The system may enable a target residual concentration of PFA to be maintained to achieve optimal disinfection efficiency and to meet microbial limits whilst remaining below toxic levels, and achieve compliance with regulatory limits and restrictions, in spite of variations in water quality (for example, as determined by TSS content and organic matter content), water quantity, and microbial levels which could otherwise affect the level of residual of PFA and reduce disinfection performance. Furthermore, as the level of residual PFA is itself dependent upon the microbial content and water quality, the system may advantageously obviate the need for performing any microbial counts in the water (for example, by laborious and time-consuming plating methods) and/or any assessment of water quality. Consequently, a reduced level of residual PFA in the system may suggest a poor water quality and/or high microbial counts, and conversely, an increased level of residual PFA in the system may suggest good water quality and/or low microbial counts. Additionally, by maintaining target residual PFA concentrations in the system and minimizing fluctuations in residual PFA concentration which could exceed toxicity limits, in some embodiments, water treated by the system may not require any further treatment with a quenching agent (for example, sodium thiosulphate).

Other disinfectants such as PAA may not be as effective as PFA, nor may they be an appropriate target for regulation in the systems described herein. As described above, PFA has an increased oxidation potential compared to PAA and accordingly, a greater disinfection efficiency. Therefore, lower levels of PFA and shorter contact times are required to achieve required disinfection. Furthermore, PFA is less stable and more susceptible to degradation than PAA. As such, the level of residual PFA may be more responsive to changes in water quality, water quantity and microbial levels than PAA within comparable contact times, and PAA may not serve as a useful indicator of water quality and/or microbial levels in the systems described herein. Furthermore, the combined effect of the higher level of PAA required for disinfection and increased stability may result in higher residual levels of PAA that would be difficult to regulate using the system of the invention, and that would, instead, require quenching.

The following are intended as examples only and do not limit the present disclosure.

### EXAMPLES

### Example 1—PFA Efficacy and Water Quality

The disinfection efficacy of PFA against fecal coliform and E. coli was assessed in wastewater (WW) that had undergone secondary treatment (S1), and in a mixed wastewater sample comprising 50% wastewater that had undergone secondary treatment and 50% wastewater that had undergone primary treatment without secondary treatment (S2). The S2 sample would have inevitably contained higher levels of TSS, increased organic matter and increased microbial content.

WW samples were collected and stored at 4° C. 9.5% until use (within 1 to 3 days). A PFA solution was prepared immediately prior to use by mixing 2.5 mL of 35% hydrogen peroxide with 2.5 mL of DEX®-A375 (a mixture of formic and sulfuric acids). The resultant mixture was incubated for 5 minutes at 4° C. and subsequently for 25 minutes at room temperature to complete formation of the 9.5% PFA solution. The 9.5% PFA solution was diluted to 950 mg/L by adding 0.2 mL of the 9.5% PFA solution to 19.8 mL distilled water.

WW samples were dosed with PFA to determine efficacy after set contact times. A shorter 30 minute contact time was used for the S2 samples to emulate the shorter contact times that would occur in a CSO event when the volume and rate of flow of water through the WW treatment system is increased. A longer 90 minute contact time was used for the S1 samples to emulate the longer contact times that would occur under normal (dry) conditions. After the specified contact time, disinfection was halted by quenching with 4 mL of a sodium thiosulfate solution (0.01 N). E. coli and total coliform colonies were then enumerated from 100 mL samples using the USEPA approved method 10029. Specifically, 100 mL treated WW samples were filtered through a 0.45 mm membrane filter. The filter membrane was transferred to a petri dish containing a pad with m-ColiBlue24 broth media. The petri dishes were inserted in Whirl-Pak bags before being incubated at 35° C. for 24 hours to retain moisture. After incubation, the number of colonies was counted. Red colonies indicate coliforms, and blue colonies indicate specific E. coli. Ideally, the plates with 20 to 80 coliform colonies were used to determine the concentration of total coliforms and E. coli in the sample.

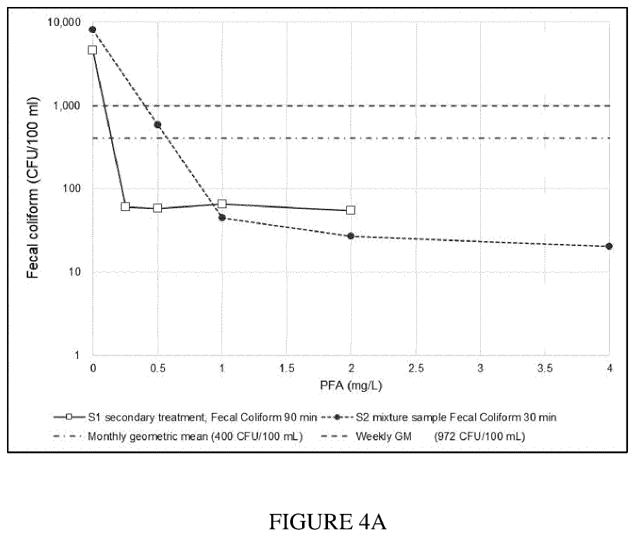

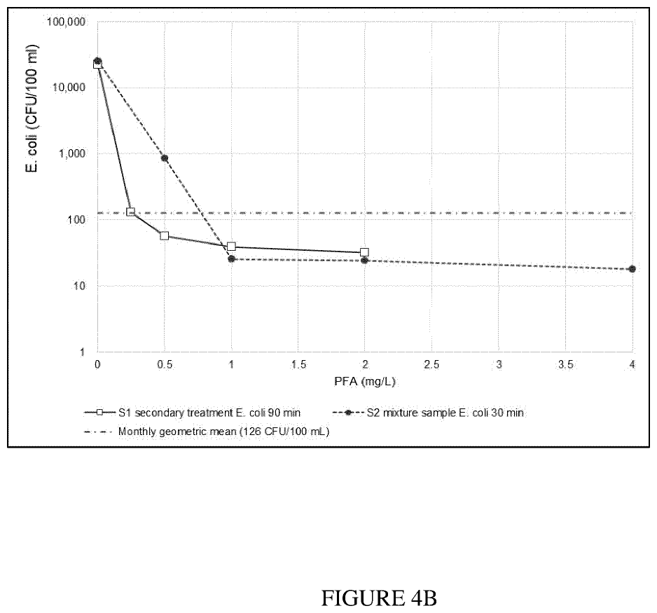

It can be seen from FIGS. 4A and 4B that the disinfection efficacy of PFA is significantly reduced in the S2 samples. Specifically, a higher dose of PFA is needed in the S2 samples to achieve a comparable reduction in microbial counts. These data demonstrate that water quality negatively affects PFA disinfection performance and higher doses of PFA are required to achieve satisfactory disinfection.

### Example 2—Residual PFA and Water Quality

Varying doses of PFA (0.5 ppm, 1 ppm, and 2 ppm) were dosed into S1 and S2 wastewater samples as described in Example 1. Residual levels of PFA were measured using a CHEMetrics test kit for PAA with vacuum ampules detecting in the 0-5 ppm range (Maffettone, 2020). PFA values were obtained by multiplying the PAA results by 0.82 (Maffettone, 2020). The factor of 0.82 for conversion of PAA to PFA corresponds to the molecular weight ratio of PFA (62.02 g/mol) to PAA (76.05 g/mol). Due to the fast degradation of PFA, residual PFA concentrations were determined immediately following the sample collection.

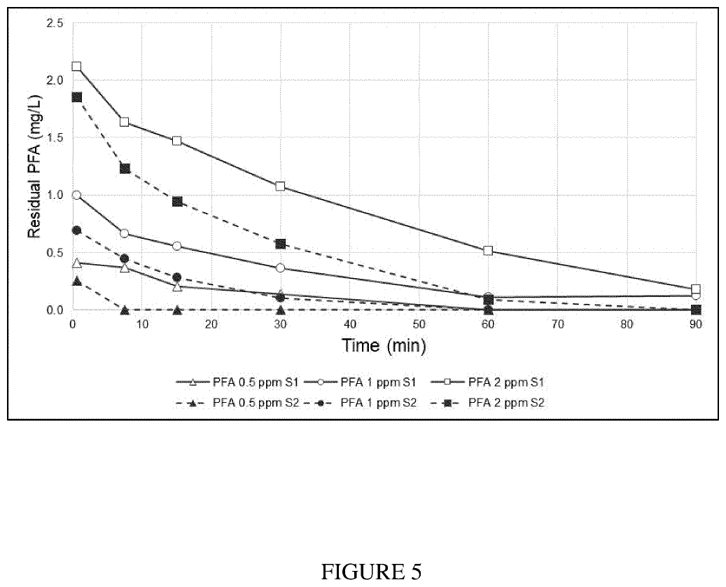

It can be seen from FIG. 5 that residual PFA levels decrease more rapidly over time in S2 samples than in S1 samples. These data confirm that PFA degrades faster in wastewater of poorer quality comprising higher levels of TSS, increased organic matter and increased microbial content.

### Example 3—Online Monitoring of Residual PFA

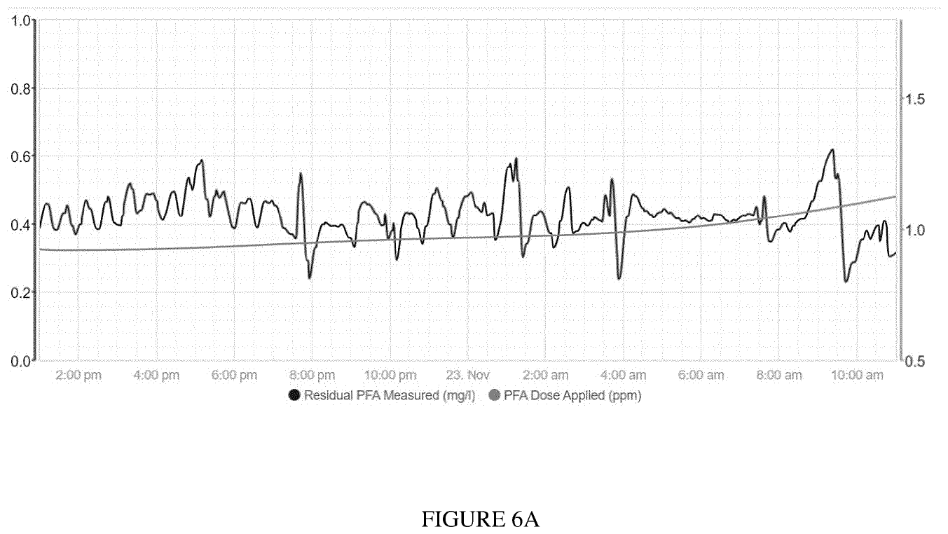

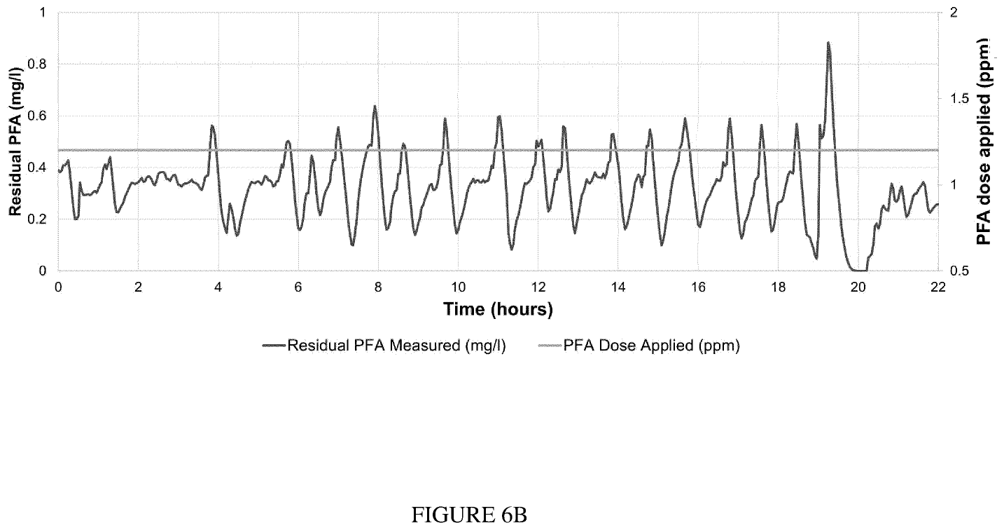

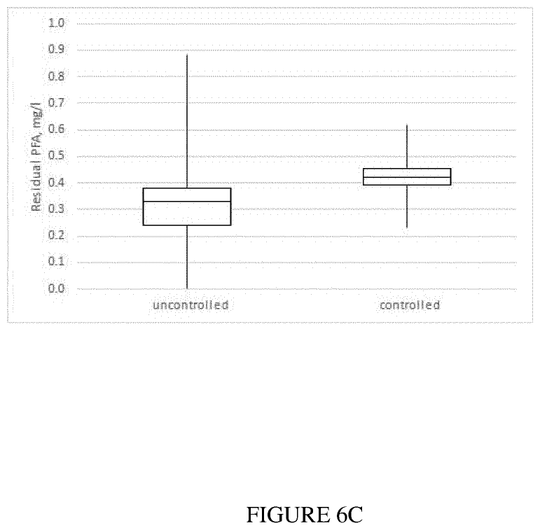

KemConnect DEX technology with a Hach® Cl-17 device was tested in a pilot run at a wastewater treatment plant (WWTP). The wastewater to be treated came from the clarifiers and was sent to a contact tank using a centrifugal pump for treatment with PFA. The DEX unit was installed inside the plant and it produced 10.4±0.7% PFA. The wastewater was treated with 1.1 mg/L PFA for 15 minutes retention time in the contact tank. After treatment, the residual PFA in the wastewater was monitored over a period of 22 hours by the Hach® Cl-17 device, connected to the KemConnect DEX system. The target residual PFA concentration was set at 0.5 ppm. During the pilot, the residual PFA concentration was mostly maintained at around or below 0.5 ppm PFA without significant fluctuation. The standard deviation of the measured values of concentration of residual PFA over the 22 hour period was calculated to be 0.06. The applied PFA dose was varied depending on the concentration of residual PFA (FIG. 6A). In addition, no significant difference between PFA-treated and untreated WW was found during the pilot run when tested for pH, COD (Chemical Oxygen Demand), TSS, alkalinity, and ammonia confirming the suitability of PFA as a WW disinfectant (data not shown).

As a comparative control, a pilot run for WW treatment was performed over a 22 hour period using a fixed applied dose of PFA of 1.2 ppm. As above, measurements were commenced after a 15 minute retention time. As illustrated in FIG. 6B, when the dose of PFA is fixed, the concentration of residual PFA varies significantly. The target concentration of 0.5 ppm is frequently exceeded with values reaching as high as about 0.9 ppm, and on many occasions, the concentration of residual PFA falls below 0.2 ppm and even reaches zero at 20 hours. A residual PFA concentration of less than 0.2 ppm (or a total absence of PFA) would not provide sufficient (or any) disinfection for WW. The standard deviation of the measured values of concentration of residual PFA over the 22 hour period was calculated to be 0.13, more than a 2-fold increase with respect to the standard deviation that is observed when the PFA dose is controlled. FIG. 6C illustrates the significant difference between variation in level of residual PFA when the PFA dose is fixed (“uncontrolled”) and when the PFA dose is varied by the system of the invention (“controlled”). The vertical whiskers represent the minimum and maximum measured concentrations of residual PFA. The horizontal box lines represent (from bottom to top) the residual PFA concentration at the 25^{th} quartile, 50^{th} quartile (mean) and 75^{th} quartile. FIG. 6C confirms that when the PFA dose is fixed, there is a much larger variation in the concentration of residual PFA as measured over the 22 hour period and larger difference in the range of values of concentration residual PFA, as compared to when the PFA dose is varied by an exemplary system of the invention.

### Example 4—Online Testing of PFA Concentration

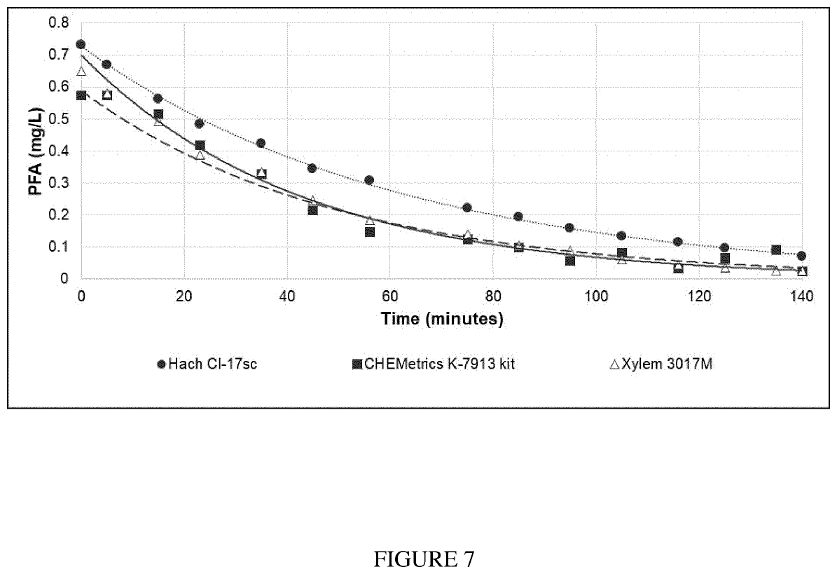

The ability of two online devices (Hach® Cl-17 and Xylem®-3017M) to measure PFA levels was tested and compared against an established manual DPD-based method for measuring PFA (CHEMetrics K-7913 kit). Both online devices were set up in the lab, and both devices were fed from the same tank containing secondary effluent with PFA. As illustrated in FIG. 7, both online devices provided good correlation with the manual method.

Other variants or use cases of the disclosed techniques may become apparent to the person skilled in the art once given the disclosure herein. The disclosure is not limited by the described embodiments but only by the accompanying claims.

1-30. (canceled)

31. A water treatment system comprising:
at least one chamber comprising an inlet for receiving water and an outlet for discharging water therefrom,
a dosing device configured to feed performic acid to the water in the at least one chamber to produce treated water,
a measuring device configured to measure the level of performic acid in the treated water and generate output data relating to the measured level of performic acid,
and a control apparatus operatively connected to the dosing device and measuring device,
wherein the control apparatus is constructed and arranged to receive the output data relating to the measured level of performic acid from the measuring device, monitor the measured level of performic acid present in treated water, and to regulate the amount of performic acid that is fed to the water by the dosing device based on the monitored level of performic acid.

32. The system of claim 31, wherein the system is configured such that the level of performic acid is measured online.

33. The system of claim 31, wherein the dosing device further comprises a reaction vessel adapted to produce performic acid.

34. The system of claim 31, wherein the measuring device comprises: (i) an amperometric sensor; (ii) a colorimetric sensor; or (iii) a DPD (N,N-diethyl-p-phenylenediamine) analyzer.

35. The system of claim 31, wherein the control apparatus is configured to cause one or both of: (i) the dosing device to increase the amount of performic acid that is fed to water in the at least one chamber when the monitored level of performic acid is below a pre-set value; and (ii) the dosing device to reduce the amount of performic acid that is fed to water in the at least one chamber when the monitored level of performic acid is above a pre-set value.

36. The system of claim 31, wherein the water treatment system is a wastewater treatment system.

37. The system of claim 36, wherein the system is further configured to perform one or more of: (i) primary wastewater treatment; (ii) secondary wastewater treatment; and (iii) tertiary wastewater treatment.

38. The system of claim 37, wherein: (i) in a first configuration, the at least one chamber is arranged to receive wastewater which has been subjected to primary treatment without secondary treatment or tertiary treatment, wherein in a second configuration, the at least one chamber is arranged to receive wastewater which has been subjected to primary treatment and secondary treatment, and optionally, tertiary treatment, and wherein the system is adapted to switch between the first and second configurations, or (ii) in a first configuration, the at least one chamber is arranged to receive wastewater which has been subjected to primary and secondary treatment, wherein in a second configuration, the at least one chamber is arranged to receive wastewater which has been subjected to primary, secondary and tertiary treatment, and wherein the system is adapted to switch between the first and second configurations.

39. The system of claim 38, wherein the first configuration is activated when the volume of wastewater flowing through the system is above a pre-set value and wherein the second configuration is activated when the volume of wastewater flowing through the system is below the pre-set value.

40. The system of claim 38, wherein the control apparatus is configured to cause the dosing device to feed an increased amount of performic acid to the wastewater in the first configuration relative to the second configuration.

41. The system of claim 37, wherein the primary treatment comprises one or more of: screening, sedimentation and sludge removal, and/or wherein the secondary treatment comprises one or more of: biofiltration, biological oxidation, and sludge activation, and/or wherein the tertiary treatment comprises one or more of: filtration, removal of nitrogen, removal of phosphorus, and disinfection.

42. The system of claim 31, wherein the control apparatus comprises at least one processor and at least one memory including a computer program code, the at least one memory and the computer program code configured, with the at least one processor, to cause the control apparatus to receive the output data relating to the measured level of performic acid from the measuring device, monitor the level of performic acid present in treated water, and to regulate the amount of performic acid that is fed to the water by the dosing device.

43. A method for treating water using the system of claim 31, the method comprising:
receiving water;
feeding performic acid to the water to form treated water;
measuring the level of performic acid in the treated water,
monitoring the level of performic acid in the treated water and regulating the amount of performic acid that is fed to the water based on the monitored level of performic acid.

44. The method of claim 43, wherein the level of performic acid is measured online.

45. The method of claim 43, wherein the performic acid is produced in situ.

46. The method of claim 43, wherein performic acid is measured by: (i) an amperometric method; (ii) a colorimetric method; or (iii) using a DPD (N,N-diethyl-p-phenylenediamine) analyzer.

47. The method of claim 43, wherein in the method one or both of: (i) the amount of performic acid fed to water is increased when the monitored level of performic acid is below a pre-set value; and (ii) the amount of performic acid fed to water is decreased when the monitored level of performic acid is above a pre-set value.

48. The method of claim 43, wherein the water treatment system is a wastewater treatment system.

49. The method of claim 48, wherein the method comprises performing one or more of: (i) primary wastewater treatment; (ii) secondary wastewater treatment; and (iii) tertiary wastewater treatment.

50. The method of claim 49, wherein the method comprises: (i) receiving wastewater which has undergone primary treatment without secondary or tertiary treatment when the volume of wastewater received is above a pre-set value, and wherein the method comprises receiving wastewater which has undergone primary treatment and secondary treatment, and optionally, tertiary treatment, when the volume of wastewater received is below a pre-set value; or (ii) receiving wastewater which has undergone primary treatment and secondary treatment when the volume of wastewater received is above a pre-set value, and wherein the method comprises receiving wastewater which has undergone primary, secondary and tertiary treatment when the volume of wastewater received is below a pre-set value.

51. The method of claim 50, wherein the amount of performic acid fed to the received wastewater is increased when the volume of wastewater received is above a pre-set value, and wherein the amount of performic acid fed to the received wastewater is decreased if the volume of wastewater received is below the pre-set value.

52. The method of claim 49, wherein the primary treatment comprises one or more of: screening, sedimentation and sludge removal, and/or wherein the secondary treatment comprises one or more of: biofiltration, biological oxidation, and sludge activation, and/or wherein the tertiary treatment comprises one or more of: filtration, removal of nitrogen, removal of phosphorus, and disinfection.
